(19) United States
(12) Patent Application Publication
(10) Pub. No.: US 2008/0169866 A1
(43) Pub. Date: Jul. 17, 2008

(54) Combined charge storage circuit and bandgap reference circuit

(75) Inventors: Bendik Kleveland, Santa Clara, CA (US); Thomas H. Lee, Burlingame, CA (US)

Correspondence Address: BRINKS HOFER GILSON & LIONE, P.O. BOX 10395, CHICAGO, IL, 60610, US

(73) Assignee: ZeroG Wireless, Inc.

(21) Appl. No.: 11/653,570

(22) Filed: Jan. 16, 2007

(51) Int. Cl. G05F 1/10; G05F 3/16

(52) U.S. Cl. 327/539; 323/313

(57) ABSTRACT

A combined charge storage and bandgap reference is disclosed. In one embodiment, a system comprises a bandgap reference circuit; a charge storage circuit, wherein an output of the bandgap reference circuit is provided as an input to the charge storage circuit; and a control circuit in communication with the bandgap reference circuit and the charge storage circuit. The control circuit is operative to control charging of the charge storage circuit by the output of the bandgap reference circuit and control selection of one of the output of the bandgap reference circuit and an output of the charge storage circuit. Other embodiments are disclosed, and each of the embodiments can be used alone or together in combination.

### BACKGROUND

A bandgap reference circuit is used to generate accurate internal voltages and currents that are independent of the external power supply voltage and temperature. One way to implement such a circuit is to add a voltage that increases with temperature (PTAT) to a voltage that decreases with temperature (CTAT). This is readily implemented by comparing junction voltages of two bipolar transistors that are biased at different current densities. See B. Razavi, “Design of Analog CMOS Integrated Circuits,” pages 377-393, 2001. The drawback of this approach is the finite current bias required to extract this voltage. An ideal circuit would simply store a reference voltage on a zero-leakage capacitor. This would reduce the current consumed by the reference voltage generator to that of the supporting circuits, as shown by B. K. Ahuja, et al., “A Very High Precision 500-nA CMOS Floating-Gate Analog Voltage Reference,” IEEE Journal of Solid-State Circuits, vol. 40, no. 12, pp. 2364-2372, December 2005. Unfortunately, conventional CMOS technology does not have the double poly available in the EEPROM process of Ahuja et al. Moreover, the qualification required to make sure that the capacitor is indeed close to zero leakage is prohibitively long for most fabless companies that are using the reference voltage as only one of several components in a custom circuit or system-on-a-chip (SoC) solution.

### SUMMARY

The present invention is defined by the claims, and nothing in this section should be taken as a limitation on those claims.

By way of introduction, the embodiments described below provide a combined charge storage circuit and bandgap reference circuit. In one embodiment, a system comprises a bandgap reference circuit; a charge storage circuit, wherein an output of the bandgap reference circuit is provided as an input to the charge storage circuit; and a control circuit in communication with the bandgap reference circuit and the charge storage circuit. The control circuit is operative to control charging of the charge storage circuit by the output of the bandgap reference circuit and control selection of one of the output of the bandgap reference circuit and an output of the charge storage circuit. Other embodiments are disclosed, and each of the embodiments can be used alone or together in combination.

The embodiments will now be described with reference to the attached drawings.

### BRIEF DESCRIPTION OF THE DRAWINGS

FIG. 1 is an illustration of a combined bandgap reference circuit and a charge storage circuit of an embodiment.

FIG. 2 is an illustration of an embodiment of a charge storage circuit with buffered charge storage on transistor M1.

FIG. 3 is an illustration of an embodiment of a charge storage circuit with unbuffered charge storage on transistor M1.

FIG. 4 is an illustration of an embodiment of a charge storage circuit with non-volatile charge storage on transistor M1 with respect to ground.

FIG. 5 is an illustration of an embodiment of a charge storage circuit with non-volatile charge storage on transistor M1 with respect to Vdd.

FIG. 6A is an illustration of an embodiment showing a voltage regulator from an external Vdd to Vchip.

FIG. 6B is an illustration of an embodiment showing a voltage regulator from an external Vdd to Vchip with a zero-power voltage regulator.

FIG. 7 is an illustration of an embodiment showing a combined bandgap reference circuit and a charge storage circuit for generation of a low-voltage (e.g., <1.2V) reference.

### DETAILED DESCRIPTION OF THE PRESENTLY PREFERRED EMBODIMENTS

The following embodiments use a combination of a bandgap reference circuit and a charge storage circuit to lower the average power of the bandgap reference circuit. These embodiments can be implemented with conventional CMOS technology, can achieve lower average current consumption as compared to using a conventional bandgap reference circuit alone (e.g., in one embodiment, less than about 20 nA), and can provide excellent power rejection to Vdd noise. One application of these embodiments is in a mobile device that operates with a battery. To save battery power, the mobile device can be placed in a “standby” mode. However, even when in the standby mode, certain components in the mobile device will require a bandgap voltage, and the bandgap reference circuit will still need to be powered. For example, it may be desired to provide bandgap voltage to a volatile memory (e.g., SRAM) to store an IP address in the standby mode, so that when the mobile device is taken out of standby mode, it can quickly “wake up” and connect to the stored IP address. Accordingly, even though the mobile device is in the standby mode and, therefore, should draw as little battery power as possible, there is still a relatively significant draw on the battery due to the bandgap reference circuit being powered. Other devices, such as, but not limited to, wireless remote controls, can encounter similar problems.

The embodiments described herein use a charge storage circuit in combination with a bandgap reference circuit. The bandgap reference circuit is used to charge the charge storage circuit. When the charge storage circuit attains the desired bandgap reference voltage, the bandgap reference circuit is disable, and the charge storage circuit (instead of the bandgap reference circuit) provides the bandgap voltage to the appropriate components. The bandgap reference circuit can be enabled (periodically or otherwise) to recharge the charge storage circuit as needed. Because the bandgap reference circuit is not continuously powered in this embodiment, this embodiment uses less battery power than implementations where the charge storage circuit is not used.

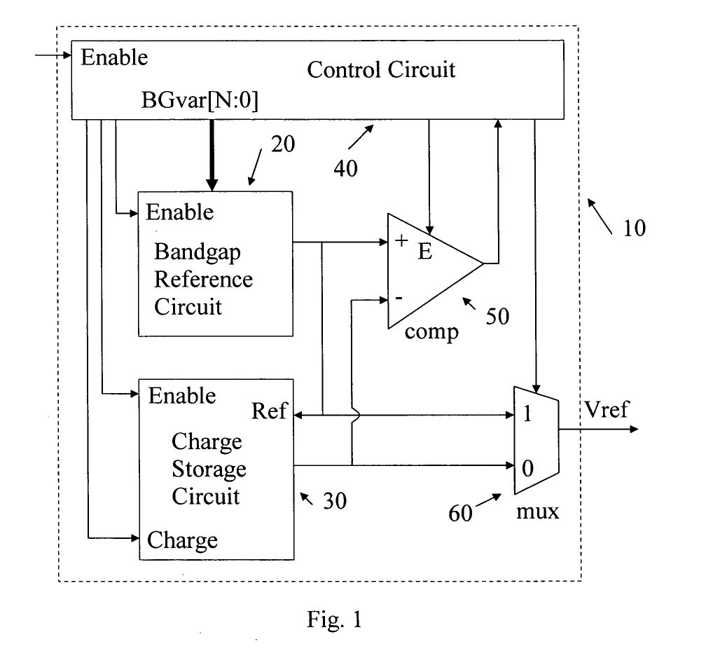

Turning now to the drawings, FIG. 1 is an illustration of a system 10 of an embodiment. The system 10 comprises a bandgap reference circuit 20, a charge storage circuit 30, a control circuit 40, a comparator 50, and a multiplexer 60. Outputs of the control circuit 40 are provided as “enable” inputs of the bandgap reference circuit 20, charge storage circuit 30, and comparator 50. When the control circuit 40 is enabled, the control circuit 40 can enable the bandgap reference circuit 20, the charge storage circuit 30, or both, as well as the comparator 50. When the control circuit 40 enables the bandgap reference circuit 20, the bandgap reference circuit 20 generates an output, which is provided as an input to the charge storage circuit 30, as well as to one of the inputs of the comparator 50 and multiplexer 60. Similarly, when the control circuit 40 enables the charge storage circuit 30, the charge storage circuit 30 generates an output, which is provided to the other one of the inputs of the comparator 50 and multiplexer 60. An output of the control circuit 40 is provided as a control input to the multiplexer 60 to controls selection of one of the output of the bandgap reference circuit and the output of the charge storage circuit that are provided an inputs to the multiplexer 60. When the control circuit 40 both enables the charge storage circuit 30 and provides a signal to the “charge” input of the charge storage circuit 30, the charge storage circuit 30 is charged by the output of the bandgap reference circuit 20. In this way, the control circuit 40 controls charging of the charge storage circuit 30 by the output of the bandgap reference circuit 20.

In operation, the control circuit 40 provides an enable signal to the bandgap reference circuit 20 and both an enable signal and a charge signal to the charge storage circuit 30 to charge the charge storage circuit 30 with the output of the bandgap reference circuit 20. When the charge storage circuit 30 is properly charged, the control circuit 40 can disable both the bandgap reference circuit 20 and the comparator 50 and then control the multiplexer 60 to provide the output of the charge storage circuit 30. In this way, the system 10 would provide the desired reference voltage without the current and power consumption needed by system that only uses a bandgap reference circuit.

To ensure that the output of the charge storage circuit 30 is within the proper tolerance for use as a reference, the comparator 50 compares the outputs of the control circuit 40 and the bandgap reference circuit 20. By adjusting the digital fine control of the bandgap reference circuit 20 (BGvar[N:0]) (e.g., by plus or minus 50 or 100 milli-volts), the control circuit 140 can determine whether the charge storage circuit 30 is within the proper tolerance for use as a reference. If there is not enough charge in the charge storage circuit 30, the control circuit 40 can program up the charge storage circuit 30 again. This could be done with several iterations until the desired voltage has been reached. The control circuit 40 can then power down the bandgap reference circuit 20 and the comparator 50 and then select the output of the charge storage circuit 30 with the multiplexer 60 (i.e., by selecting input 0). The control circuit 40 can regularly power up the bandgap reference circuit 20 and the comparator 50 (periodically or otherwise) to check the voltage drooping of the charge storage circuit 30. Furthermore, if the charge storage circuit 30 has very low leakage, the control circuit 40 can reduce the frequency of checking the voltage drooping of the charge storage circuit 30 to reduce the overall power even further.

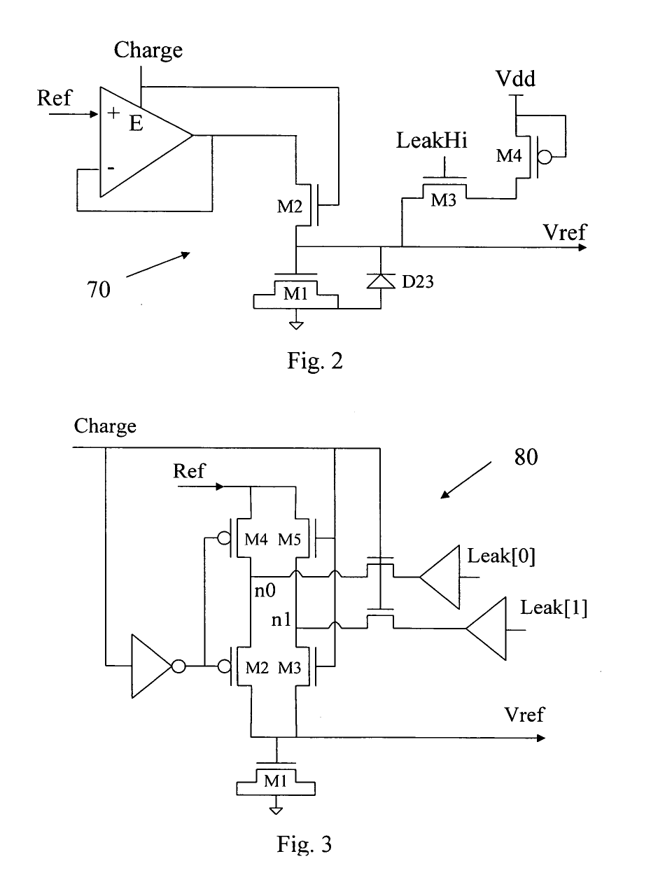

The bandgap reference circuit 20 can be implemented in any suitable manner, including commonly-used conventional implementations. See, for example, B. Razavi, “Design of Analog CMOS Integrated Circuits,” pages 377-393, 2001; and B. K. Ahuja, et al., “A Very High Precision 500-nA CMOS Floating-Gate Analog Voltage Reference,” IEEE Journal of Solid-State Circuits, vol. 40, no. 12, pp. 2364-2372, December 2005, which are both hereby incorporated by reference. An example of one implementation 70 of the charge storage circuit 30 is shown in FIG. 2. In this example, the charge storage circuit 30 provides buffered charge storage. Here, the reference voltage is stored as a charge on the gate of transistor M1, which acts as a capacitor. This capacitor is charged to the reference voltage provided by the bandgap reference circuit 20 when the control circuit 40 raises the “charge” signal from low to high. When the “charge” signal is turned off (i.e., lower from high to low), the only leakage paths from the capacitor (Vref) to ground are through the parasitic diodes of the drains of transistors M2 and M3. This diode is explicitly drawn as D23 in FIG. 2. Over time, the leakage will cause the voltage to droop lower. An additional leakage path to Vdd can be enabled by setting “LeakHi” high. The leakage to Vdd is now through transistor M3 (on) and transistor M4 (off). The control circuit 40 can be designed to evaluate different duty cycles of “LeakHi” to find the setting that averages a close-to-zero leakage, resulting in even longer times between calibrations.

A simple calculation of the time constant of the leakage follows. Assume that a 10 mV voltage variation on Vref can be tolerated before calibration. Assume further that a leakage in the order of 1 pA at room temperature is achievable. By using transistor M1 with dimensions that yield a capacitance of about 0.1 nF, the time is given by:

dt=C dV/I=0.1 e-9×10 e-3/1 e-12=1 s

For the average power consumption, assume that about 100 μA for about 200 μs is needed every time calibration is performed. A calibration performed every second provides an average power of 100 μA×200 e-6/1 s=20 nA. Further reduction can be achieved by using a larger transistor M1 yielding a higher capacitance. The Vdd power supply rejection of supply noise of a passive capacitor to ground is also excellent.

At low temperatures, the diode leakages will generally be lower, enabling even less frequent calibrations. At high temperatures, however, the diode leakages increase, which may require more frequent calibrations. The control circuit 40 can either use a temperature input to decide on the frequency of the calibrations, or it could simply start with frequent calibrations and then reduce the frequency of the calibrations as it learns. Many ultra-low power circuits do not have any high-power circuits that generate heat. Hence, those ultra-low power circuits will benefit from infrequent calibrations, resulting in an extremely-low average power consumption.

An example of another implementation 80 of the charge storage circuit 30 is shown in FIG. 3. In this example, the charge storage circuit 30 provides unbuffered charge storage. The bandgap reference circuit 20 is connected directly to a capacitor (i.e., the gate of transistor M1, through pass-gate M2-M5) during refresh, enabling even smaller area (because no buffering occurs) and lower power charging, as compared to the buffered charge storage implementation 70 in FIG. 2. Additionally, to facilitate lower leakage, the M2-M5 pass-gate is implemented with two series transistors. When the pass-gate is off, these internal nodes could float to Vdd or ground depending on the junction leakages. By forcing these nodes to known potentials (e.g., ground or Vdd-Vt, as shown in FIG. 3), it is possible to implement four possible leakage states. The control circuit 40 could be implemented to cycle through the four states and use the lowest leakage setting for the charge storage, resulting in the most-infrequent recharge time and, therefore, also the lowest average power.

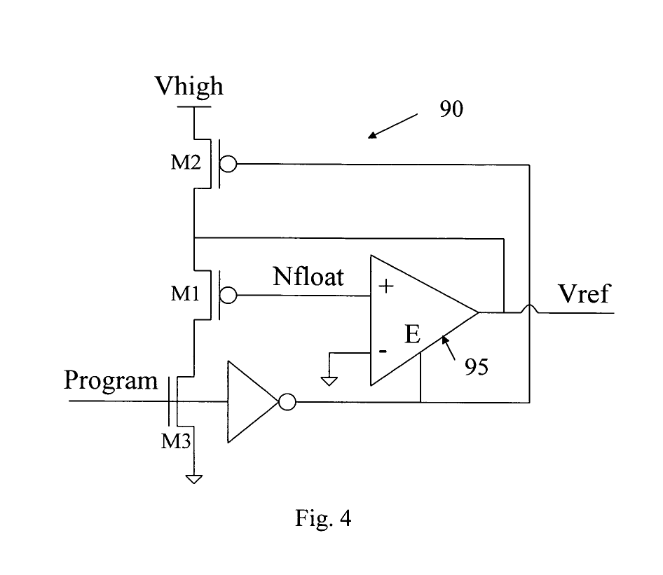

Another example of an implementation 90 of the charge storage circuit 30 is shown in FIG. 4. This implementation uses the principle of non-volatile storage with single poly technology used in the original FAMOS cells. See D. Frohmann-Bentchkowsky, “A Fully-Decoded 2048-Bit Electrically-Programmable FAMOS Read-Only Memory,” IEEE Journal of Solid-State Circuits, vol. sc-6, no. 5, pp. 301-306, October 1971; and D. Frohmann-Bentchkowsky, “A Fully-Decoded 2048-Bit Electrically-Programmable MOS-ROM,” 1971 IEEE International Solid-State Circuits Conference, Digest of Technical Papers, pp. 80, 81, and 200, February 1971, both of which are hereby incorporated by reference. The charge is trapped by electron injection into a PMOS transistor (M1) when Vpp is biased at high voltage and the “Program” signal is high. This electron injection results in a negative charge on the node “Nfloat” with respect to the n-well. After a programming pulse, the “Program” signal is forced low, and the unity gain feedback forces the floating programmed node “Nfloat” to ground, resulting in the positive voltage (Vref) appearing on at the output of the op-amp 95.

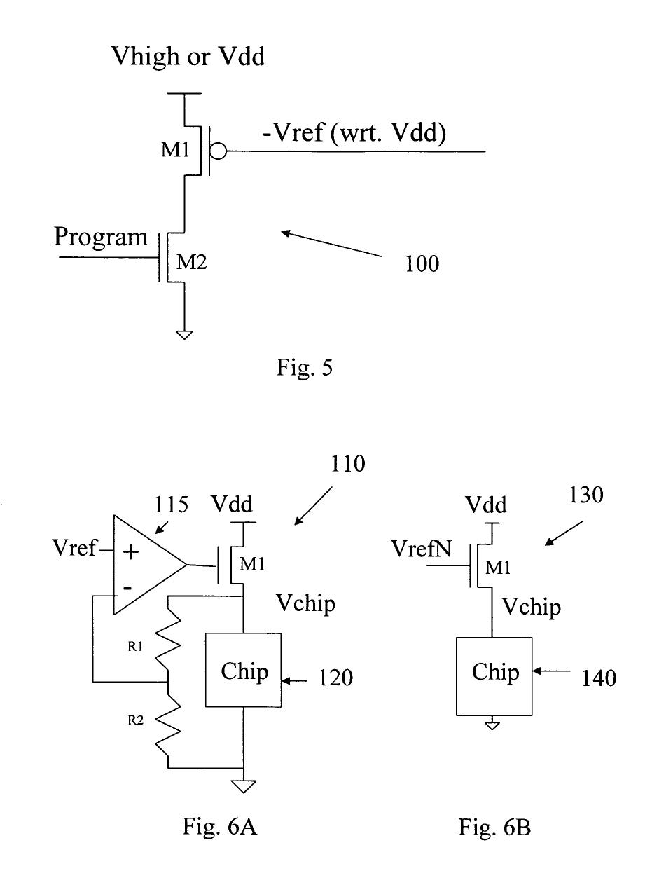

An even simpler variation of this non-volatile storage is shown in circuit 100 in FIG. 5. Here, the reference voltage is with respect to Vdd, and no op-amp is used. To program the cell, a high voltage is applied to the source of M1 (Vpp), and the “Program” signal is forced high. Again, electrons are injected into the floating node, resulting in a negative voltage on the floating node with respect to the drain and source. In read mode, the source is connected to Vdd. Since the transistor is on, a channel is formed causing both the source and drain to be at the potential of Vdd, resulting in the floating node being at a negative potential to Vdd. In many existing applications, a reference voltage with respect to ground is preferred. However, the advantage of a zero-power voltage reference circuit (such as the one shown in FIG. 5 that needs very infrequent calibration) may change that. The leakage of the floating node is a strong function of the process technology and the gate oxide chosen. However, without any diffusions connected to the node, this circuit 100 has the potential of providing a zero-power bandgap for months.

Having generated an essentially zero-power reference voltage (Vref), a very low power voltage regulator for a chip can be achieved—dominated by the power of the control circuit of the regulator. An example of a regulator 110 is illustrated in FIG. 6A. A voltage reference is used as one input of an operational amplifier 115. The output is connected to a large transistor M1 that drives the local chip power supply 120. The feedback loop assures that Vchip is tracking the regulator with the scaling determined by the ratio of R1 and R2 [Vchip=Vref*(R1+R2)/R2]. This voltage regulator could, therefore, be used to supply, say a 1.8V supply from an external voltage that may vary from 2.5V to 3.6V (e.g., two batteries in series that droop over time). The current of the regulator would be just limited by the op-amp 115 and the resistors R1 and R2. By using high-value resistors and a low-current design of the operational amplifier 115, the total current from these components can be made quite small (e.g., 0.1-10 μA).

For further improvement, an approximate voltage regulator can be achieved using zero current, as shown in the circuit 130 in FIG. 6B. This is possible by exploiting the fact that the source follower (M1) has a small variation of voltage across the gate and the source for a large variation of current. Thus, for a native NMOS device with about zero threshold voltage, the voltage at the gate is approximately equal to the voltage at the source, hence VrefN=Vchip. This zero-power voltage follower voltage regulator combined with the essentially zero-power reference voltage can save power during standby operation and still maintain the approximate voltage supply in the chip 140. Thus, a register and SRAM state can be preserved during standby, and low-power circuits such as timers can still be running off of the Vchip supply during variations in the external supply. An R1/R2 network similar to that shown in FIG. 6A could be used to set the VrefN to the required value (scaled from Vref). The advantage of this scheme is that the power of the comparators and resistors is only consumed during the time of the comparison with the bandgap, thus yielding a combined bandgap and regulator design that consumes the average current in the order of 10 nA using the techniques described herein.

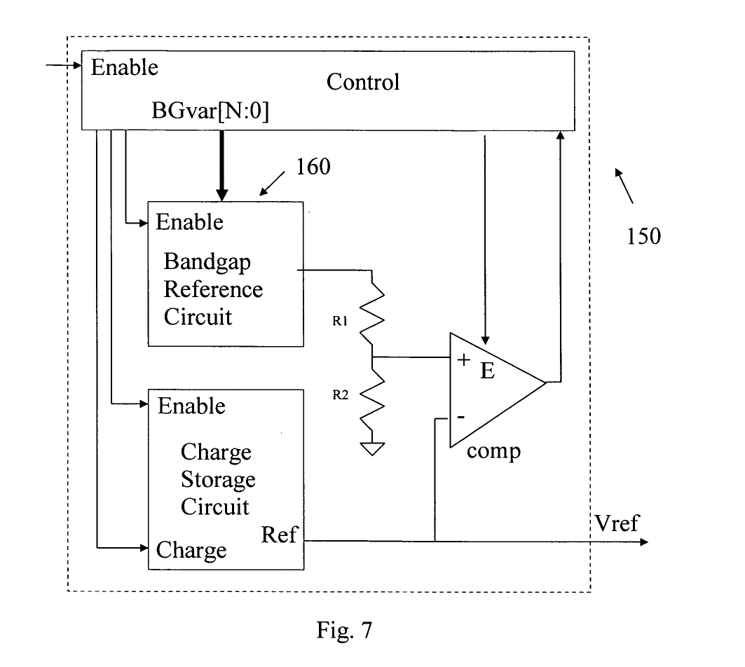

Turning again to the drawings, FIG. 7 is an illustration of an embodiment showing a system 150 with a combined bandgap reference circuit 160 and a charge storage circuit for generation of a low-voltage (e.g., <1.2V) reference. As compared to the system 10 in FIG. 1, this system 150 has two resistors R1 and R2 that serve to scale down the voltage supplied by the conventional bandgap reference circuit 160. Accordingly, this system 150 generates a voltage reference that is lower than the bandgap voltage. This system 150 will become more and more relevant as the technology and the supply voltages scale progressively lower. Alternative techniques are possible, such as those described in Banba et al., “A CMOS Bandgap Reference Circuit with Sub-1-V Operation,” IEEE Journal of Solid-State Circuits, vol. 34, pp. 670-674, May 1999, which is hereby incorporated by reference. However, these alternative techniques are generally more complicated and/or more power consuming than a conventional bandgap reference circuit.

Finally, it should be understood that a “circuit,” as that term is used herein, can be implemented in any suitable manner and with any suitable components and should not be limited to any particular type of implementation described herein. A “circuit” can take the form of, for example, a set of basic hardware components (e.g., transistors, resistors, etc.), an application specific integrated circuit (ASIC), a programmable logic controller, an embedded microcontroller, and a single-board computer. Also, while a circuit can be implemented purely with hardware, a circuit can also be implemented with both hardware and software (e.g., a processor running computer-readable program code). Further, one component can be “in communication” with another component directly or indirectly through one or more components named or unnamed herein, either through a physical or wireless medium. Also, an output of one component can be provided as an input to another component when the output is in direct communication with the input or is in indirect communication with the input through one or more components named or unnamed herein, either through a physical or wireless medium.

It is intended that the foregoing detailed description be understood as an illustration of selected forms that the invention can take and not as a definition of the invention. It is only the following claims, including all equivalents, that are intended to define the scope of this invention.

What is claimed is:

1. A system having both a bandgap reference circuit and a charge storage circuit, the system comprising:
a bandgap reference circuit;
a charge storage circuit, wherein an output of the bandgap reference circuit is provided as an input to the charge storage circuit; and
a control circuit in communication with the bandgap reference circuit and the charge storage circuit, the control circuit operative to:
control charging of the charge storage circuit by the output of the bandgap reference circuit; and
control selection of one of the output of the bandgap reference circuit and an output of the charge storage circuit.

2. The system of claim 1 further comprising:
a comparator, wherein the outputs of the bandgap reference circuit and the charge storage circuit are provided as inputs to the comparator, and wherein an output of the comparator is provided as an input to the control circuit.

3. The system of claim 2 further comprising:
a circuit, between the bandgap reference circuit and the comparator, operative to reduce the output of the bandgap reference circuit before it is provided to the comparator.

4. The system of claim 3, wherein the circuit comprises resistors.

5. The system of claim 1 further comprising:
a multiplexer, wherein the outputs of the bandgap reference circuit and the charge storage circuit are provided as inputs to the multiplexer, and wherein the control circuit controls selection of the one of the output of the bandgap reference circuit and the output of the charge storage circuit by controlling the multiplexer.

6. The system of claim 1, wherein the control circuit is operative to determine if the charge storage circuit should be recharged by the output of the bandgap reference circuit.

7. The system of claim 1, wherein the charge storage circuit provides buffered charge storage.

8. The system of claim 1, wherein the charge storage circuit provides unbuffered charge storage.

9. The system of claim 1, wherein the charge storage circuit provides non-volatile charge storage on a transistor with respect to ground.

10. The system of claim 1, wherein the charge storage circuit provides non-volatile charge storage on a transistor with respect to Vdd.

11. The system of claim 1, wherein the charge storage circuit comprises a CMOS component.

12. The system of claim 1, wherein the system is implemented in one of a mobile device and a wireless remote control.

13. The system of claim 1, wherein an output of the system is provided as an input to a transistor of a voltage regulator.

14. A method for using a system having both a bandgap reference circuit and a charge storage circuit, the method comprising:
providing an output of a bandgap reference circuit as an input to a charge storage circuit;
charging the charge storage circuit by the output of the bandgap reference circuit; and
after the charge storage circuit has been charged by the output of the bandgap reference circuit, selecting the output of the charge storage circuit instead of the output of the bandgap reference circuit.

15. The method of claim 14 further comprising:
comparing the outputs of the bandgap reference circuit and the charge storage circuit.

16. The method of claim 15 further comprising:
determining if the charge storage circuit should be recharged.

17. The method of claim 14, wherein selecting the output is performed by providing a control signal to a multiplexer, wherein the outputs of the bandgap reference circuit and the charge storage circuit are provided as inputs to the multiplexer.

18. The method of claim 14, wherein the charge storage circuit provides buffered charge storage.

19. The method of claim 14, wherein the charge storage circuit provides unbuffered charge storage.

20. The method of claim 14, wherein the charge storage circuit provides non-volatile charge storage on a transistor with respect to ground.

21. The method of claim 14, wherein the charge storage circuit provides non-volatile charge storage on a transistor with respect to Vdd.

22. The method of claim 14, wherein the charge storage circuit comprises a CMOS component.

23. The method of claim 14, wherein the method is performed in one of a mobile device and a wireless remote control.

24. The method of claim 14 further comprising:
providing an output of the system as an input to a transistor of a voltage regulator.

25. The method of claim 14 further comprising:
reducing the output of the bandgap reference circuit before it is compared with the output of the charge storage circuit.

26. The method of claim 25, wherein the output of the bandgap reference circuit is reduced using resistors.
